(19) United States
(12) Patent Application Publication
(10) Pub. No.: US 2023/0342449 A1
(43) Pub. Date: Oct. 26, 2023

(54) HARDWARE ATTESTATION IN A MULTI-NETWORK INTERFACE DEVICE SYSTEM

(71) Applicant: Intel Corporation, Santa Clara, CA (US)

(72) Inventors: Eoin WALSH, Limerick (IE); Francesc GUIM BERNAT, Barcelona (ES); Padraig CONNOLLY, Limerick (IE); Daniel SHEA, Chandler, AZ (US); Ned SMITH, Beaverton, OR (US)

(21) Appl. No.: 18/215,752

(22) Filed: Jun. 28, 2023

(51) Int. Cl. G06F 21/44

(52) U.S. Cl. CPC G06F 21/44

(57) ABSTRACT

Examples described herein relate to a network interface device that includes a network interface, one or more processors, and circuitry to: register the network interface device and based on selection as an attestation device by the management controller from among multiple candidate network interface devices, receive attestation information and perform attestation of one or more devices.

### BACKGROUND

Edge computing seeks to place compute and data storage resources physically closer to data sources and data receivers to reduce latency of processing and accessing data and reduce network bandwidth utilization. Edge cloud architectures utilize network interface devices such as Intel® Infrastructure Processing Units (IPUs) to manage the infrastructure and allow central processing units (CPUs), graphics processing units (GPUs), and other processors (e.g., xPU) to execute core application-level functions.

### BRIEF DESCRIPTION OF THE DRAWINGS

FIG. 1 depicts an example system.

FIG. 2 depicts an example system.

FIGS. 3A-3C depict example systems.

FIG. 4 depicts an example process.

FIG. 5 depicts an example system.

FIG. 6 depicts an example network interface device.

FIG. 7 depicts an example network interface device.

### DETAILED DESCRIPTION

Multiple network interface devices can be connected to a host system, such as a server. In a system with multiple network interface devices connected to one or more servers, various examples described herein can select a network interface device to take a role of primary network interface device and perform device attestation and, potentially, configure devices when connected to a network (e.g., zero touch provision (ZTP)). A selected network interface device can provide an end customer (e.g., tenant, cloud service provider (CSP), or communications service provider (CoSP)) with capability to attest to system and device reliability and provide access to attested devices. As Edge sites are distributed, having the ability to attest the validity of devices in the infrastructure can reduce human activity and associated cost but also provide a central or centralized source of truth for hardware validation. In the context of edge-cloud architectures, a selected network interface device can provide a single source of truth regarding trustworthiness status of devices accessible in an edge node.

Note that while examples herein are described with respect to Edge or edge computing, examples can apply to any environments, such as data centers, servers within a rack, or other systems.

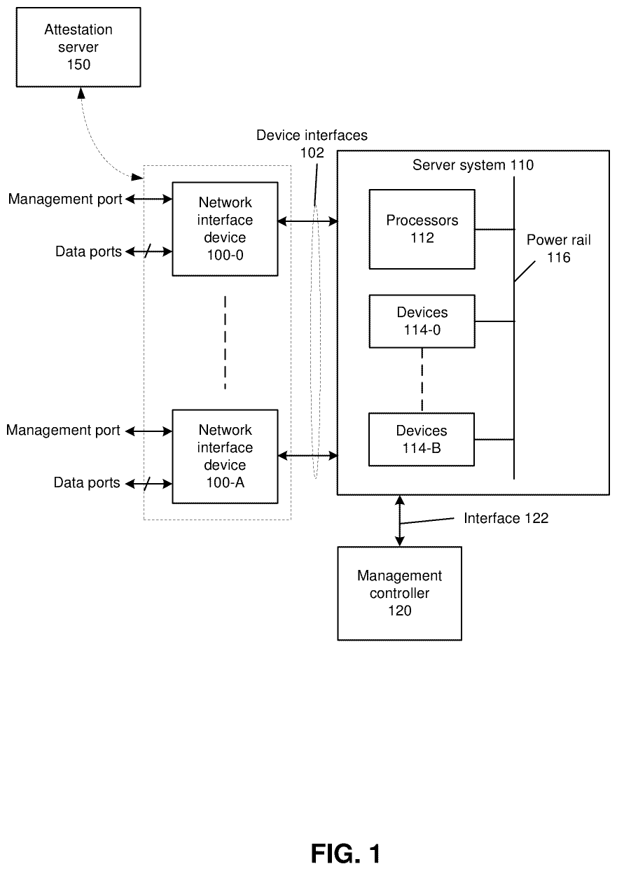

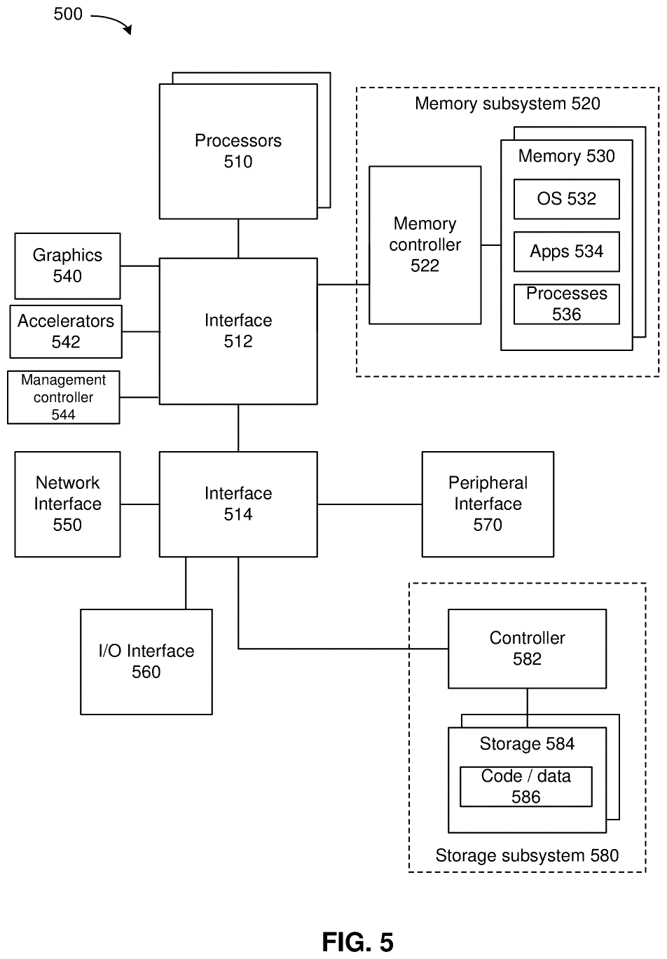

FIG. 1 depicts an example system or platform. Network interface devices 100-0 to 100-A, where A is an integer, can be communicatively coupled to server system 110 via device interfaces 102. In some examples, network interface devices 100-0 to 100-A can refer to one or more of: a network interface controller (NIC), a remote direct memory access (RDMA)-enabled NIC, SmartNlC, router, switch, forwarding element, infrastructure processing unit (IPU), data processing unit (DPU), or network-attached appliance. Server system 110 can include various devices and circuitry and execute software described at least with respect to FIG. 5. For example, devices interfaces 102 can provide communications consistent with Peripheral Component Interconnect express (PCIe), Compute Express Link (CXL), or other standards.

Management controller 120 can perform management and monitoring capabilities for system administrators to monitor operation at least of server system 110 (and devices connected thereto) and network interface devices 100-0 to 100-A using channels, including out-of-band channels. Out-of-band channels can include packet flows or transmission media that communicate metadata and telemetry and may not communicate data. In some examples, management controller 120 can be communicatively coupled to server system 110 using interface 122 (e.g., a device interface (e.g., PCIe or CXL) or other interface (e.g., I2C or I3C)). Management controller 120 can be implemented as one or more of: Board Management Controller (BMC), Intel® Management or Manageability Engine (ME), or other devices. One or more of network interface devices 100-0 to 100-A can include a host interface, direct memory access (DMA) engine, and network interface.

For example, at or after initial server boot up, an overview of an attestation flow can be performed as follows. At (1), a controller (e.g., a core of processors 112) or microcontroller can start a boot for system 110. For example, devices 114-0 to 114-B, where B is an integer, that are connected to power rail 116 can receive power and can commence boot. Devices 114-0 to 114-B can include one or more of: processor, memory, storage, accelerator, network interface device, or others. At (2), one or more processor cores of processors 112 can be a default root of trust (RoT). At (3), using out of band (OOB) or in-band communications, a trusted source (e.g., management controller 120 or a core of processors 112) can change a root of trust to one of network interface devices 100-0 to 100-A, as described herein. For example, a trusted source can utilize a communication protocol between one or more of network interface devices 100-0 to 100-A to negotiate and determine which network interface device is to perform attestation of devices of the system. For example, a communication protocol over PCIe can be utilized to communicate information used to negotiate and determine which network interface device is to perform attestation for the system.

At (4), secure data transfer techniques can be used for passing system base configuration information (e.g., evidence) from one or more of devices 114-0 to 114-B to the attestation owner or lead attester (e.g., a processor or core of one of network interface devices 100-0 to 100-A, a CPU core, or management controller 120). At (5), lead attester can communicate with an attestation server 150 to attest devices 114-0 to 114-B. Where a network interface device is selected as a lead attester (e.g., based on Remote Attestation procedures (RATS) Architecture (RFC 9334) (2023)), it can utilize network connectivity with attestation server 150 to attest devices. In some examples, attestation server 150 can provide a signed token that includes a hash value, epoch (e.g., length of time) to repeat attestation, and expiration date that can be used by the attestation owner to provide proof of the attestation to the other devices connected to power rail 116.

In some examples, optionally, one or more of the devices 114-0 to 114-B can connect to an attestation authority (e.g., attestation server 150) that can validate that the attestation outcome performed by the attestation owner or lead attester is valid to check that the attestation owner has not been compromised and is trustworthy.

In some examples, one or more cores of processors 112 can act as lead or primary attestation owner and network interface devices 100-0 to 100-A can act as subordinate attestors or local attestors. A core can receive a platform root of trust (RoT) key and attest network interface devices 100-0 to 100-A. As local attesters, network interface devices 100-0 to 100-A can gather information from devices 114 connected to power rail 116 concerning device hardware and/or firmware, and provide the gathered information to the lead or primary attester. A core or processor of network interface devices 100-0 to 100-A can be assigned one or more seed values to validate keys associated with information provided by devices 114.

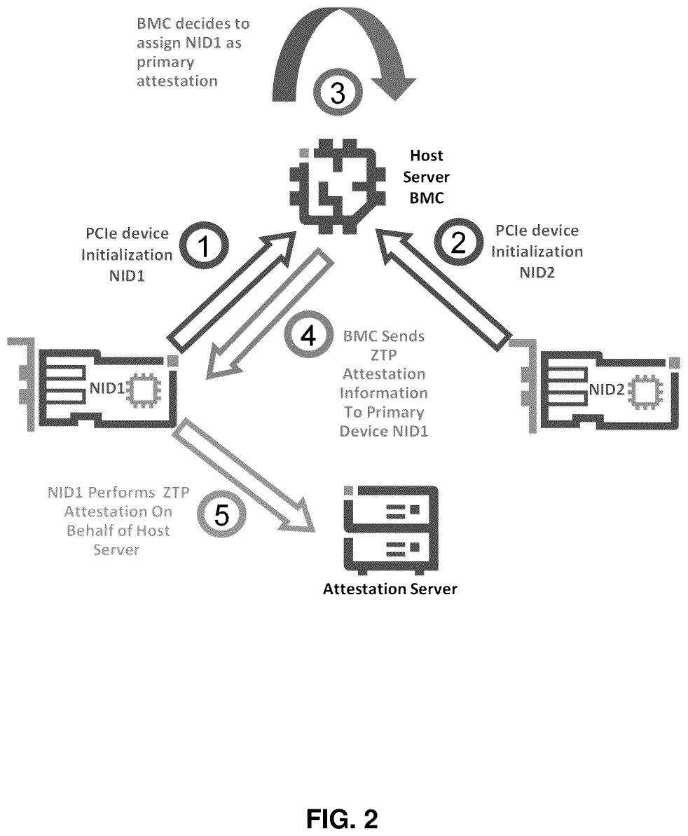

FIG. 2 depicts an example attestation flow. At (1), network interface device NID1 can register with the host server system over a bus (e.g., PCIe). NID1 can communicate to management controller (e.g., BMC) information to apply to be the primary attestation device. At (2), NID2 registers with the host system over a bus (e.g. PCIe) and can transmit information to management controller to apply to be the primary attestation device. At (3), host server management controller can determine which NID to assign as the primary attestation device for communication with the attestation validator server to attest devices in the system. For example, management controller can select a NID as follows. For a single NID that has requested to be the primary attestor device, management controller can assign such NID as the primary attestation device. For multiple NIDs that requested to be the primary attestor device, management controller can assign a NID as the primary attestation device based on lowest PCIe slot number or selection of a NID based on a first request received. After selection of the NID as a primary attestation device, a CPU core or management controller can determine if the selected NID is capable to be primary attestor. The selected NID can generate information including DICE RoT key generated using MCHECK to a prove a key is owned by the NID. The CPU core, or BMC can transmit a digest to remote attestation server to verify that the selected NID can be a primary attestor.

At (4), the host server management can share attestation information (e.g., evidence that can include one or more of a device PASID or firmware identifier) for the server over the PCIe bus with the NID assigned and accepted as the primary attestation device. At (5), the NID selected to be primary attestation device, on behalf of the host server, can perform the ZTP attestation process with the remote attestation server. After attestation server perform validation, attestation server can provide an attestation token to the attestation owner (e.g., selected NID). The attestation token can include one or more of: result of the attestation, epoch or time when the attestation was performed, expiration date, Unique ID for the attestation, or signature. Thereafter, the NID selected to be primary attestation device can attest to whether devices are authorized for use at least by software, an operating system, or driver.

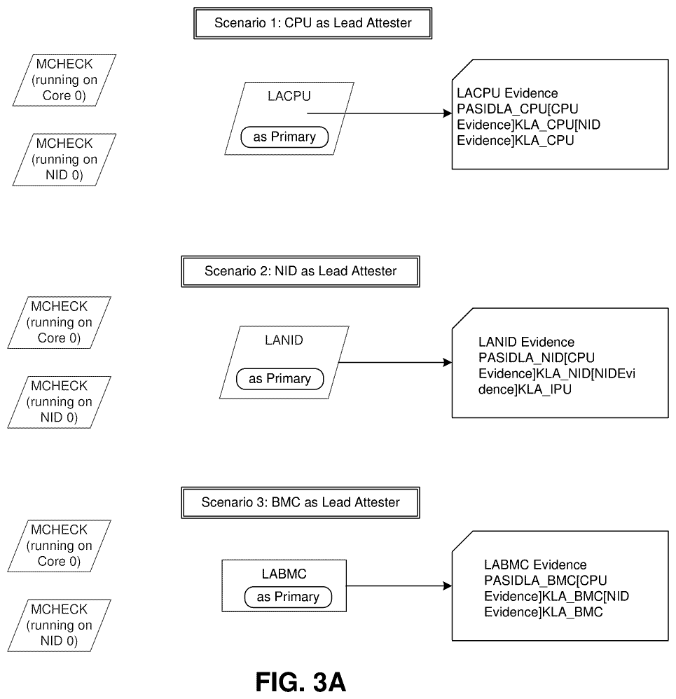

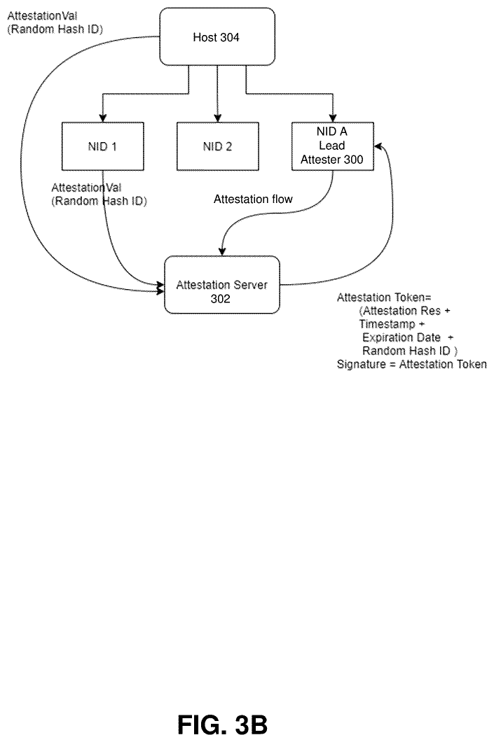

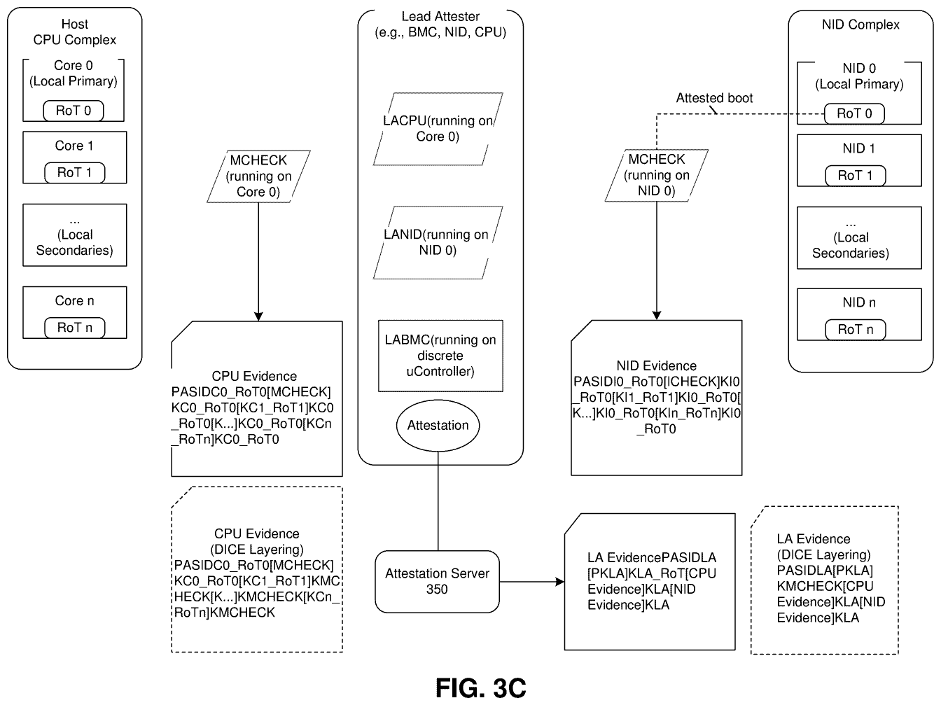

FIG. 3A illustrates examples of platform level lead attesters. A lead attester can be implemented as one or more of the following: (1) one of the cores in the CPU complex or one or more processors in a GPU, (2) one of the cores or processors in the IPU complex, or (3) a management controller in the platform. In scenario 1, a CPU complex hosts a platform level lead attester (LA). Where a CPU core perform LA role, the CPU core can perform an MCHECK operation and/or follow a boot sequence consistent with Device Identifer Composition Engine (DICE) to perform a proof of possession protocol for at least one of the secondary cores in the CPU to verify that the cores are in possession of a valid RoT key. A device Process Address Space ID (PASID) can be included in device evidence. PASID can be used to provide identity of devices and can be used as a context identifier for evidence. For example, the CPU core can measure MCHECK code, produce a digest, and generate a seed of a key using the digest to generate K_{MCHECK}. K_{MCHECK} can be used to sign evidence collected by the lead attester (e.g., LA CPU or LA_{CPU}) from devices. Lead attester may also store a signing key that was generated from a root of trust (K_{LA_ROT}) or a key derived using DICE, namely K_{MCHECK}.

In scenario 2, a network interface device core hosts the platform level lead attester. Where a network interface device processor performs an LA role, the network interface device processor can perform an MCHECK operation to verify keys of other cores and/or network interface device(s).

In scenario 3, a management controller can act as platform level lead attester and can perform an MCHECK operation to verify keys of other cores and/or network interface device(s). In some examples, the management controller can sign evidence with a key derived from an internal RoT key.

In scenarios 1, 2, and 3, the lead attester can forward the signed LA evidence (e.g., LA_{CPU} evidence, LA_{NID} evidence, LA_{BMC} evidence, or device evidence) to a verifier (e.g., attestation server) for verification.

FIG. 3B depicts an example operation in which a network interface device is lead attester. In this example, NID A 300 acts as lead attester for the platform and can perform an attestation flow with attestation server 302 to attest and verify devices that provide evidence to NID A 300. Attestation server 302 can provide an attestation token to NID A 300 that indicates an attestation result (res) (e.g., attested or not attested), timestamp of attestation, expiration of token. The token can permit NID A 300 to attest devices in the platform until expiration of the token. Other systems (e.g., host 304, NID 1, NID 2, or others) can communicate with attestation server 302 to retrieve the attestation result from NID N 300 to verify that NID N 300 is applying device verification and attestation from attestation server 302.

FIG. 3C shows both the CPU and network interface device bootstrap involving local primaries. In some examples, in a CPU complex, a CPU core that boots first can act as a local primary attester. In some examples, in a network interface device, a core or processor that boots first can act as a local primary attester. In some examples, the local primary in the CPU complex and the network interface device can execute MCHECK and verify other cores in the CPU complex. The local primary core can perform initialization of other cores for the other cores to produce evidence. Evidence can include one or more of a device PASID or firmware identifier or DICE layered evidence such as DICE Attestation Architecture version 1.00, revision 0.23 (2021). A local primary can aggregate evidence from different cores and provide the evidence to a lead attester. The local primary can provide the evidence to a lead attester to communicate with attestation server 350 to verify evidence.

A negotiation protocol may allow lead attesters to simultaneously assert themselves as lead attester to local primary and then (e.g., randomly) select a backoff wait time before reasserting a request to be lead attester. The lead attester that picked the shortest backoff time can resend the assertion to another lead attester. The lead attester that receives an assertion from a peer lead attester before sending its own assertion, can accept the requesting lead attester as the primary lead attester, and set itself to be a secondary lead attester. The lead attester can collect the evidence from the primary and secondary lead attesters and communicate with attestation server 350 in order to verify evidence from the lead attesters and determine which devices, if any, are authorized for use. Note that attestation of devices and their firmware can occur periodically, triggered by firmware update, or at random or pseudo-random intervals so that devices and their firmware are verified for use more than one time.

A workload that runs on the CPU complex or a NID could be migrated to another core, so attestation for a CPU complex (or NID) can cause cores of the CPU complex (or NID) to report core keys in the CPU complex (or NID). Secondary core keys can be reported as a digest of the public key to the primary attester. The digest can identify the secondary core key to remote verifiers, that may certify chain validation for each key based on checks against a certificate revocation list (CRL). In some examples, a remote verifier (e.g., attestation server 350) can trust that the local primary (e.g., CPU or network interface device that runs MCHECK) that performed checks of proof-of-key possession.

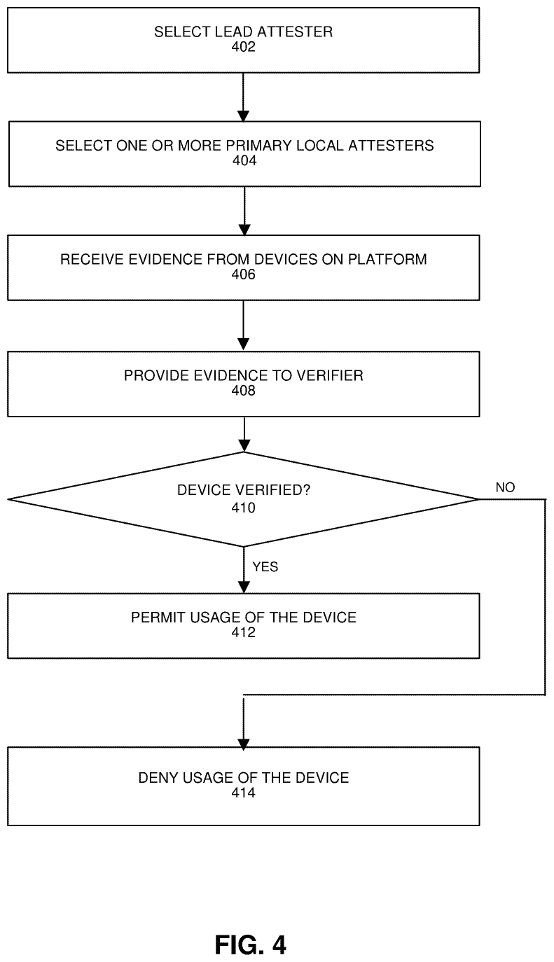

FIG. 4 depicts an example process. The process can be performed to select a lead attester to attest devices connected to a platform. At 402, a lead attester can be selected. For example, a lead attester can be selected as a first core in a CPU or network interface device that requests to be lead attester to the management controller and that generates credentials that indicate that it can be a lead attester. In some examples, the lead attester can be selected to be a management controller in the platform. At 404, one or more local primary attesters can be selected. For example, local primary attesters can be selected as a first core in a CPU or network interface device that boots or draws power from a power rail and commences a proof of possession protocol for other cores of the CPU or network interface device to verify the other cores are in possession of RoT keys. At 406, the lead attester can request and receive evidence from devices in the platform. Evidence can include device identifiers such as a PASID or key or firmware identifier. For example, the lead attester can receive device evidence from the local primary attesters. At 408, the lead attester can provide the device evidence to a verifier. For example, a verifier can include an attestation server. At 412, the lead attester can permit usage of one or more devices that presented evidence that is accepted by the verifier at 410. Conversely, at 414, the lead attester can deny usage of one or more devices that presented evidence that was not accepted by the verifier at 410.

FIG. 5 depicts a system. The system can perform device attestation using circuitry (e.g., processor core of processors 510 or graphics 540 or core of network interface 550) or management controller 544, as described herein. System 500 includes processors 510, which provides processing, operation management, and execution of instructions for system 500. Processors 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processors 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 510 can include one or more processor sockets.

In some examples, interface 512 and/or interface 514 can include a switch (e.g., CXL switch) that provides device interfaces between processors 510 and other devices (e.g., memory subsystem 520, graphics 540, accelerators 542, network interface 550, and so forth).

In one example, system 500 includes interface 512 coupled to processors 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. A management controller 562 can be coupled to interface 512 and management controller 544 can perform device attestation, as described herein.

Accelerators 542 can be a programmable or fixed function offload engine that can be accessed or used by a processors 510. For example, an accelerator among accelerators 542 can provide compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processors 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Applications 534 and/or processes 536 can refer instead or additionally to a virtual machine (VM), container, microservice, processor, or other software. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processors 510 or a physical part of interface 512. For example, memory controller 522 can be an integrated memory controller, integrated onto a circuit with processors 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

In some examples, network interface 550 can be implemented as a network interface controller, network interface card, a host fabric interface (HFI), or host bus adapter (HBA), and such examples can be interchangeable. Network interface 550 can be coupled to one or more servers using a bus, PCIe, CXL, or DDR. Network interface 550 may be embodied as part of a system-on-a-chip (SoC) that includes one or more processors, or included on a multichip package that also contains one or more processors.

Some examples of network device 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processors 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processors 510 or can include circuits or logic in processors 510 and interface 514.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-volatile Memory Express (NVMe) over Fabrics (NVMe-oF) or NVMe.

In some examples, system 500 can be implemented using interconnected compute nodes of processors, memories, storages, network interfaces, and other components. High speed interconnects can be used such as PCIe, Ethernet, or optical interconnects (or a combination thereof).

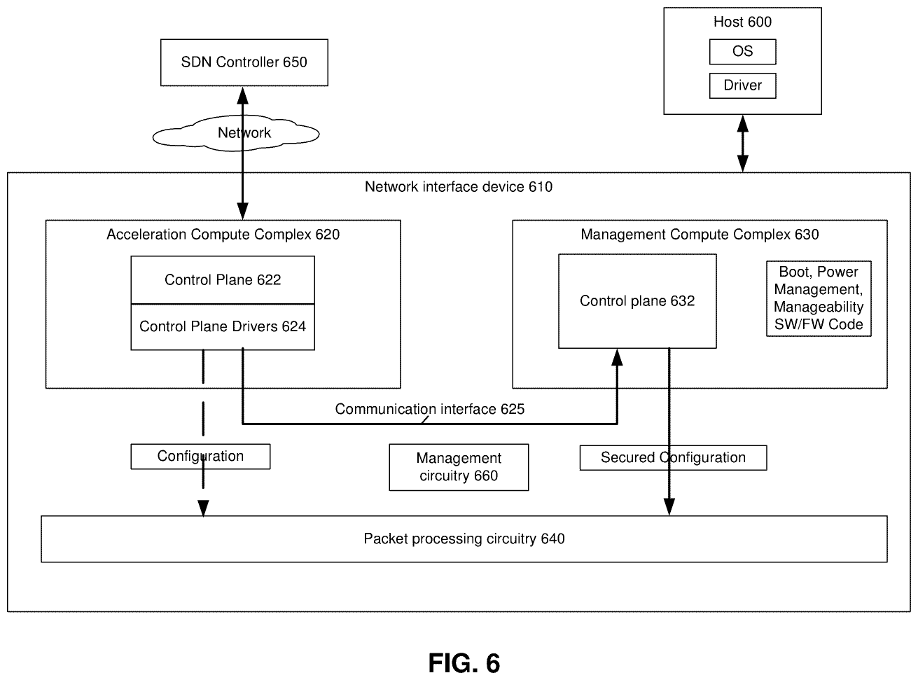

FIG. 6 depicts an example system. Host 600 can include processors, memory devices, device interfaces, as well as other circuitry such as described with respect to FIG. 5. Processors of host 600 can execute software such as applications (e.g., microservices, virtual machine (VMs), microVMs, containers, processes, threads, or other virtualized execution environments), operating system (OS), and device drivers. An OS or device driver can configure network interface device or packet processing device 610 to utilize one or more control planes to communicate with software defined networking (SDN) controller 650 via a network to configure operation of the one or more control planes.

Packet processing device or data plane circuitry 610 can include multiple compute complexes, such as an Acceleration Compute Complex (ACC) 620 and Management Compute Complex (MCC) 630, as well as packet processing circuitry 640 and network interface technologies for communication with other devices via a network. ACC 620 can be implemented as one or more of: a microprocessor, processor, accelerator, field programmable gate array (FPGA), application specific integrated circuit (ASIC) or circuitry described at least with respect to FIG. 5. Similarly, MCC 630 can be implemented as one or more of: a microprocessor, processor, accelerator, field programmable gate array (FPGA), application specific integrated circuit (ASIC) or circuitry described at least with respect to FIG. 5. In some examples, ACC 620 and MCC 630 can be implemented as separate cores in a CPU, different cores in different CPUs, different processors in a same integrated circuit, different processors in different integrated circuit.

Packet processing device 610 can include management circuitry 660 that can perform device attestation, as described herein.

Packet processing device 610 can be implemented as one or more of: a microprocessor, processor, accelerator, field programmable gate array (FPGA), application specific integrated circuit (ASIC) or circuitry described at least with respect to FIG. 5. Packet processing pipeline circuitry 640 can process packets as directed or configured by one or more control planes executed by multiple compute complexes. In some examples, ACC 620 and MCC 630 can execute respective control planes 622 and 632.

SDN controller 650 can upgrade or reconfigure software executing on ACC 620 (e.g., control plane 622 and/or control plane 632) through contents of packets received through packet processing device 610. In some examples, ACC 620 can execute control plane operating system (OS) (e.g., Linux) and/or a control plane application 622 (e.g., user space or kernel modules) used by SDN controller 650 to configure operation of packet processing pipeline 640. Control plane application 622 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 650 can communicate with ACC 620 using a remote procedure call (RPC) such as Google remote procedure call (gRPC) or other service and ACC 620 can convert the request to target specific protocol buffer (protobuf) request to MCC 630. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 650 can provide packet processing rules for performance by ACC 620. For example, ACC 620 can program table rules (e.g., header field match and corresponding action) applied by packet processing pipeline circuitry 640 based on change in policy and changes in VMs, containers, microservices, applications, or other processes. ACC 620 can be configured to provide network policy as flow cache rules into a table to configure operation of packet processing pipeline 640. For example, the ACC-executed control plane application 622 can configure rule tables applied by packet processing pipeline circuitry 640 with rules to define a traffic destination based on packet type and content. ACC 620 can program table rules (e.g., match-action) into memory accessible to packet processing pipeline circuitry 640 based on change in policy and changes in VMs.

A flow can include a sequence of packets being transferred between two endpoints, generally representing a single session using a protocol. Accordingly, a flow can be identified, using a match, by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

For example, ACC 620 can execute a virtual switch such as vSwitch or Open vSwitch (OVS), Stratum, or Vector Packet Processing (VPP) that provides communications between virtual machines executed by host 200 or with other devices connected to a network. For example, ACC 620 can configure packet processing pipeline circuitry 640 as to which VM is to receive traffic and what kind of traffic a VM can transmit. For example, packet processing pipeline circuitry 640 can execute a virtual switch such as vSwitch or Open vSwitch that provides communications between virtual machines executed by host 600 and packet processing device 610.

MCC 630 can execute a host management control plane, global resource manager, and perform hardware registers configuration. Control plane 632 executed by MCC 630 can perform provisioning and configuration of packet processing circuitry 640. For example, a VM executing on host 600 can utilize packet processing device 610 to receive or transmit packet traffic. MCC 630 can execute boot, power, management, and manageability software (SW) or firmware (FW) code to boot and initialize the packet processing device 610, manage the device power consumption, provide connectivity to Baseboard Management Controller (BMC), and other operations.

One or both control planes of ACC 620 and MCC 630 can define traffic routing table content and network topology applied by packet processing circuitry 640 to select a path of a packet in a network to a next hop or to a destination network-connected device. For example, a VM executing on host 600 can utilize packet processing device 610 to receive or transmit packet traffic.

ACC 620 can execute control plane drivers to communicate with MCC 630. At least to provide a configuration and provisioning interface between control planes 622 and 632, communication interface 625 can provide control-plane-to-control plane communications. Control plane 632 can perform a gatekeeper operation for configuration of shared resources. For example, via communication interface 625, ACC control plane 622 can communicate with control plane 632 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 625 can be utilized by a negotiation protocol and configuration protocol running between ACC control plane 622 and MCC control plane 632. Communication interface 625 can include a general purpose mailbox for different operations performed by packet processing circuitry 640. Examples of operations of packet processing circuitry 640 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 625 can include one or more mailboxes accessible as registers or memory addresses. For communications from control plane 622 to control plane 632, communications can be written to the one or more mailboxes by control plane drivers 624. For communications from control plane 632 to control plane 622, communications can be written to the one or more mailboxes. Communications written to mailboxes can include descriptors which include message opcode, message error, message parameters, and other information. Communications written to mailboxes can include defined format messages that convey data.

Communication interface 625 can provide communications based on writes or reads to particular memory addresses (e.g., dynamic random access memory (DRAM)), registers, other mailbox that is written-to and read-from to pass commands and data. To provide for secure communications between control planes 622 and 632, registers and memory addresses (and memory address translations) for communications can be available only to be written to or read from by control planes 622 and 632 or cloud service provider (CSP) software executing on ACC 620 and device vendor software, embedded software, or firmware executing on MCC 630. Communication interface 625 can support communications between multiple different compute complexes such as from host 600 to MCC 630, host 600 to ACC 620, MCC 630 to ACC 620, baseboard management controller (BMC) to MCC 630, BMC to ACC 620, or BMC to host 600.

Packet processing circuitry 640 can be implemented using one or more of: application specific integrated circuit (ASIC), field programmable gate array (FPGA), processors executing software, or other circuitry. Control plane 622 and/or 632 can configure packet processing pipeline circuitry 640 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 620 or MCC 630. In some examples, a P4 program can be compiled and provided to MCC 630 to configure packet processing circuitry 640. The following is a JSON configuration file that can be transmitted from ACC 620 to MCC 630 to get capabilities of packet processing circuitry 640 and/or other circuitry in packet processing device 610. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

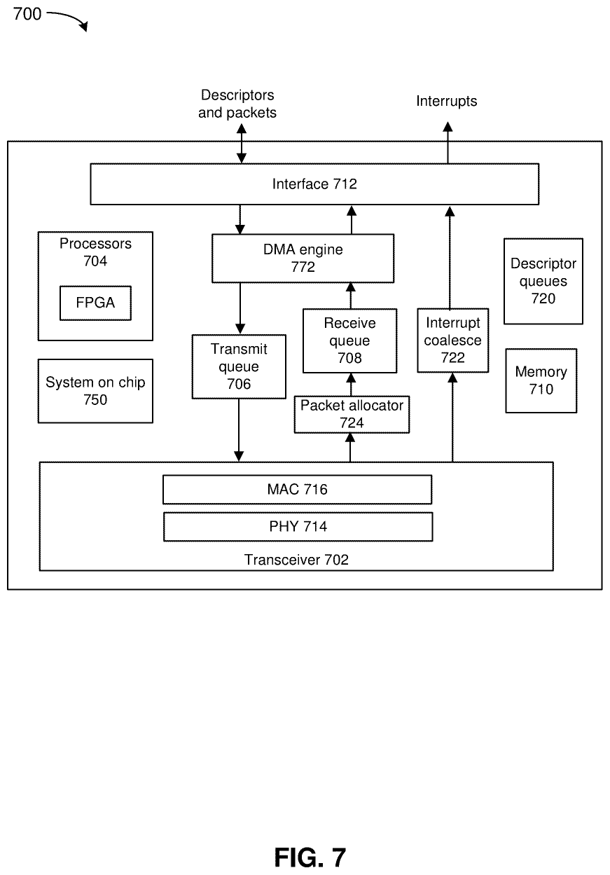

FIG. 7 depicts an example network interface device or packet processing device. In some examples, circuitry of network interface device can be utilized to perform attestation, as described herein. In some examples, packet processing device 700 can be implemented as a network interface controller, network interface card, a host fabric interface (HFI), or host bus adapter (HBA), and such examples can be interchangeable. Packet processing device 700 can be coupled to one or more servers using a bus, PCIe, CXL, or DDR. Packet processing device 700 may be embodied as part of a system-on-a-chip (SoC) that includes one or more processors, or included on a multichip package that also contains one or more processors.

Some examples of packet processing device 700 are part of an Infrastructure Processing Unit (IPU) or data processing unit (DPU) or utilized by an IPU or DPU. An xPU can refer at least to an IPU, DPU, GPU, GPGPU, or other processing units (e.g., CPU, GPU, or accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 700 can include transceiver 702, processors 704, transmit queue 706, receive queue 708, memory 710, and bus interface 712, and DMA engine 752. Transceiver 702 can be capable of receiving and transmitting packets in conformance with the applicable protocols such as Ethernet as described in IEEE 802.3, although other protocols may be used. Transceiver 702 can receive and transmit packets from and to a network via a network medium (not depicted). Transceiver 702 can include PHY circuitry 714 and media access control (MAC) circuitry 716. PHY circuitry 714 can include encoding and decoding circuitry (not shown) to encode and decode data packets according to applicable physical layer specifications or standards. MAC circuitry 716 can be configured to assemble data to be transmitted into packets, that include destination and source addresses along with network control information and error detection hash values.

Processors 704 can be any a combination of a: processor, core, graphics processing unit (GPU), field programmable gate array (FPGA), application specific integrated circuit (ASIC), or other programmable hardware device that allow programming of network interface 700. For example, a “smart network interface” can provide packet processing capabilities in the network interface using processors 704.

Processors 704 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 704, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 724 can provide distribution of received packets for processing by multiple CPUs or cores using timeslot allocation described herein or RSS. When packet allocator 724 uses RSS, packet allocator 724 can calculate a hash or make another determination based on contents of a received packet to determine which CPU or core is to process a packet.

Interrupt coalesce 722 can perform interrupt moderation whereby network interface interrupt coalesce 722 waits for multiple packets to arrive, or for a time-out to expire, before generating an interrupt to host system to process received packet(s). Receive Segment Coalescing (RSC) can be performed by network interface 700 whereby portions of incoming packets are combined into segments of a packet. Network interface 700 provides this coalesced packet to an application.

Direct memory access (DMA) engine 752 can copy a packet header, packet payload, and/or descriptor directly from host memory to the network interface or vice versa, instead of copying the packet to an intermediate buffer at the host and then using another copy operation from the intermediate buffer to the destination buffer.

Memory 710 can be any type of volatile or non-volatile memory device and can store any queue or instructions used to program network interface 700. Transmit queue 706 can include data or references to data for transmission by network interface. Receive queue 708 can include data or references to data that was received by network interface from a network. Descriptor queues 720 can include descriptors that reference data or packets in transmit queue 706 or receive queue 708. Bus interface 712 can provide an interface with host device (not depicted). For example, bus interface 712 can be compatible with PCI, PCI Express, PCI-x, Serial ATA, and/or USB compatible interface (although other interconnection standards may be used).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

What is claimed is:

1. An apparatus comprising:
a network interface device comprising:
a network interface,
memory,
one or more processors, and
circuitry to:
register the network interface device and
based on selection as an attestation device by a management controller from among multiple candidate network interface devices, receive attestation information and perform attestation of one or more devices.

2. The apparatus of claim 1, wherein the management controller is to communicate with a attestation authority to determine if the circuitry is trusted as an attestation authority.

3. The apparatus of claim 2, wherein the attestation authority comprises an attestation server.

4. The apparatus of claim 1, wherein the circuitry is to execute Linux mcheck( ) to perform verify one or more cores.

5. The apparatus of claim 1, wherein communications between the management controller and the circuitry are secured based on Peripheral Component Interconnect express (PCIe) or Compute Express Link (CXL).

6. The apparatus of claim 1, wherein the attestation information is associated with the one or more devices connected to a server and comprises device identifiers and firmware identifiers.

7. The apparatus of claim 1, wherein the attestation information is provided by one or more local attestor cores associated with a central processing unit (CPU) complex or the network interface device.

8. The apparatus of claim 1, wherein the one or more devices comprise one or more of: a processor, a graphics processing unit (GPU), an accelerator, a network interface device, a memory device, or a storage device.

9. A non-transitory computer-readable medium comprising instructions stored thereon, that if executed by one or more processors, cause the one or more processors to:
configure a management controller to select an attestation device from among multiple candidate network interface devices, wherein the selected network interface device is to receive attestation information and perform attestation of one or more devices connected to a server.

10. The non-transitory computer-readable medium of claim 9, comprising instructions stored thereon, that if executed by one or more processors, cause the one or more processors to:
the management controller to communicate with an attestation authority to determine if the selected network interface device is trusted as an attestation authority.

11. The non-transitory computer-readable medium of claim 10, wherein the attestation authority comprises an attestation server.

12. The non-transitory computer-readable medium of claim 9, wherein communications between the selected network interface device and the management controller are secured based on Peripheral Component Interconnect express (PCIe) or Compute Express Link (CXL).

13. The non-transitory computer-readable medium of claim 9, wherein the attestation information is associated with the one or more devices connected to the server and comprises device identifiers and firmware identifiers.

14. The non-transitory computer-readable medium of claim 9, wherein the attestation information is provided by one or more local attestor cores associated with a central processing unit (CPU) complex or at least one of the network interface device.

15. A method comprising:
configuring a controller to select an attestation device from among multiple candidate network interface devices, wherein the selected network interface device is to receive attestation information and perform attestation of one or more devices connected to a server.

16. The method of claim 15, comprising:
the controller communicating with an attestation authority to determine if the selected network interface device is trusted as an attestation authority.

17. The method of claim 16, wherein the attestation authority comprises an attestation server.

18. The method of claim 15, wherein communications between the selected network interface device and the controller are secured based on Peripheral Component Interconnect express (PCIe) or Compute Express Link (CXL).

19. The method of claim 15, wherein the attestation information is associated with the one or more devices connected to the server and comprises device identifiers and firmware identifiers.

20. The method of claim 15, wherein the attestation information is provided by one or more local attestor cores associated with a central processing unit (CPU) complex or at least one of the network interface device.
